(19) United States
(12) Patent Application Publication
(10) Pub. No.: US 2026/0012829 A1
(43) Pub. Date: Jan. 8, 2026

(54) METHODS AND APPARATUS OF MONITORING ARTIFICIAL INTELLIGENCE MODEL IN RADIO ACCESS NETWORK

(71) Applicant: Lenovo (Beijing) Limited, Beijing (CN)

(72) Inventors: Jianfeng Wang, Beijing (CN); Bingchao Liu, Beijing (CN); Congchi Zhang, Shanghai (CN); Tingnan Bao, Beijing (CN); Xin Guo, Beijing (CN)

(73) Assignee: Lenovo (Beijing) Limited, Beijing (CN)

(21) Appl. No.: 18/879,977

(22) PCT Filed: Jul. 1, 2022
(86) PCT No.: PCT/CN2022/103248

§ 371 Date: Dec. 30, 2024

(51) Int. Cl. H04W 24/10; H04L 41/16

(52) U.S. Cl. CPC H04W 24/10; H04L 41/16

(57) ABSTRACT

Methods and apparatus of monitoring artificial intelligence (AI) model in radio access network (RAN) are disclosed. The apparatus includes a receiver that receives a first configuration signalling for monitoring performance of one or more Artificial Intelligence (AI) models that are activated, and a second configuration signalling for reporting a result of the performance monitoring; a processor that generates a performance report of the AI models according to the first configuration signalling and the second configuration signalling; and a transmitter that transmits the performance report.

### FIELD

The subject matter disclosed herein relates generally to wireless communication and more particularly relates to, but not limited to, methods and apparatus of monitoring artificial intelligence (AI) model in radio access network (RAN).

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (CNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Physical Uplink Control Channel (PUCCH), Physical Uplink Shared Channel (PUSCH), Hybrid Automatic Repeat Request (HARQ), Acknowledgement (ACK), Hybrid Automatic Repeat Request Acknowledgement (HARQ-ACK), Physical Downlink Shared Channel (PDSCH), Physical Uplink Control Channel (PUCCH), Physical Uplink Shared Channel (PUSCH), Physical Broadcast Channel (PBCH), Block Error Rate (BLER), Control Element (CE), Channel State Information (CSI), Channel State Information Reference Signal (CSI-RS), Downlink Control Information (DCI), Frequency Division Multiple Access (FDMA), Index/Identifier (ID), Information Element (IE), Media Access Control (MAC), Media Access Control-Control Element (MAC-CE, or MAC CE), Multiple Input Multiple Output (MIMO), Physical Layer (PHY), Radio Access Network (RAN), Radio Resource Control (RRC), Reference Signal (RS), Reference Signal Received Power (RSRP), Received Signal Strength Indicator (RSSI), Subcarrier Spacing (SCS), Sounding Reference Signal (SRS), Synchronization Signal Block (SSB), Transmission and Reception Point (TRP), Frequency Range 1 (FR1), Frequency Range 2 (FR2), Layer 1 Reference Signal Received Power (L1-RSRP), Synchronization Signal (SS), Layer 1/physical layer (L1), Channel Busy Ratio (CBR), Synchronization Signals and Physical Broadcast Channel (SS/PBCH), Artificial Intelligence (AI), Machine Leaning (ML), Computer Vison (CV), Nature Language Processing (NLP), Neural Network (NN), Non Line of Sight (NLOS), Line of Sight (LOS), High-Speed Train (HST), Cross Link Interference (CLI).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

It is important to identify and specify necessary enhancements for both downlink and uplink MIMO for facilitating the use of large antenna array, not only for FR1 but also for FR2, to fulfil the request for evolution of NR deployments in Release 18.

Artificial Intelligence (AI)/Machine Learning (ML) is used to learn and perform certain tasks via training neural networks with vast amounts of data, which is successfully applied in computer vison (CV) and nature language processing (NLP) areas. As the subset of ML, Deep Learning (DL) utilizes multi-layered neural networks (NNs) as the “AI model” to learn to solve problems and optimize performance from vast amounts of data. In view of the promising benefits presented in many academic papers and field test results, the AI/ML-based methods may obtain better performance than a traditional one if well trained. In 3GPP, it is under discussion to introduce AI/ML into air interface in NR Release 18, including potential use-cases, evaluation methodologies and the framework.

Characteristics of lifecycle management of AI/ML model may be studied based on investigations and evaluations on the selected use cases, i.e., CSI feedback enhancement, beam management and positioning accuracy improvement.

Some evaluation results show that the performance of an AI-based approach with a well-trained AI model may be better than the non-AI-based approach. However, the benefit of the AI-approach much relies on the data set constructed for training. If the training input data does not have the same characteristics as the actual data set, the benefit of the AI approach is questionable. Therefore, the performance of an AI-based approach should be monitored and enabled for reasonable deployment in RAN.

In this disclosure, a set of signalings, including both MAC CE and RRC signalings, are proposed to support the relevant behaviours to monitor the AI/ML models deployed to enhance the air interface performance in RAN.

### SUMMARY

Methods and apparatus of monitoring artificial intelligence (AI) model in radio access network (RAN) are disclosed.

According to a first aspect, there is provided an apparatus, including: a receiver that receives a first configuration signalling for monitoring performance of one or more Artificial Intelligence (AI) models that are activated, and a second configuration signalling for reporting a result of the performance monitoring; a processor that generates a performance report of the AI models according to the first configuration signalling and the second configuration signalling; and a transmitter that transmits the performance report.

According to a second aspect, there is provided an apparatus, including: a transmitter that transmits a first configuration signalling for monitoring performance of one or more Artificial Intelligence (AI) models that are activated, and a second configuration signalling for reporting a result of the performance monitoring; a receiver that receives a performance report of the AI models that is generated and reported according to the first configuration signalling and the second configuration signalling.

According to a third aspect, there is provided a method, including: receiving, by a receiver, a first configuration signalling for monitoring performance of one or more Artificial Intelligence (AI) models that are activated, and a second configuration signalling for reporting a result of the performance monitoring; generating, by a processor, a performance report of the AI models according to the first configuration signalling and the second configuration signalling; and transmitting, by a transmitter, the performance report.

According to a fourth aspect, there is provided a method, including: transmitting, by a transmitter, a first configuration signalling for monitoring performance of one or more Artificial Intelligence (AI) models that are activated, and a second configuration signalling for reporting a result of the performance monitoring; receiving, by a receiver, a performance report of the AI models that is generated and reported according to the first configuration signalling and the second configuration signalling.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4A is a schematic diagram illustrating an example of using AI/ML approach to compress CSI to reduce CSI feedback overhead in accordance with some implementations of the present disclosure.

FIG. 4B is a schematic diagram illustrating an example of using AI/ML approach for beam measurement with less overhead in accordance with some implementations of the present disclosure.

FIG. 4C is a schematic diagram illustrating an example of using AI/ML approach to enhance positioning accuracy in accordance with some implementations of the present disclosure.

FIG. 5A is a schematic diagram illustrating an example of replacing a communication module with an AI model in accordance with some implementations of the present disclosure.

FIG. 5B is a schematic diagram illustrating an example of assisting a communication module with an AI model in accordance with some implementations of the present disclosure.

FIGS. 6A-6C are schematic diagrams illustrating examples of AI model deployment cases with AI model at gNB side, at UE side, and at both sides, respectively, in accordance with some implementations of the present disclosure.

FIG. 7 is a schematic diagram illustrating an example of AI model performance monitoring procedure in accordance with some implementations of the present disclosure.

FIG. 8A is a schematic diagram illustrating an example of AI model activation procedure with scenario identification at gNB or network side in accordance with some implementations of the present disclosure.

FIG. 8B is a schematic diagram illustrating an example of AI model activation procedure with scenario identification at UE side in accordance with some implementations of the present disclosure.

FIG. 9 is a schematic diagram illustrating an example of measurement trigger to monitor an activated AI model in accordance with some implementations of the present disclosure.

FIG. 10 is a flow chart illustrating steps of monitoring AI model in RAN by UE in accordance with some implementations of the present disclosure; and

FIG. 11 is a flow chart illustrating steps of monitoring AI model in RAN by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B.” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

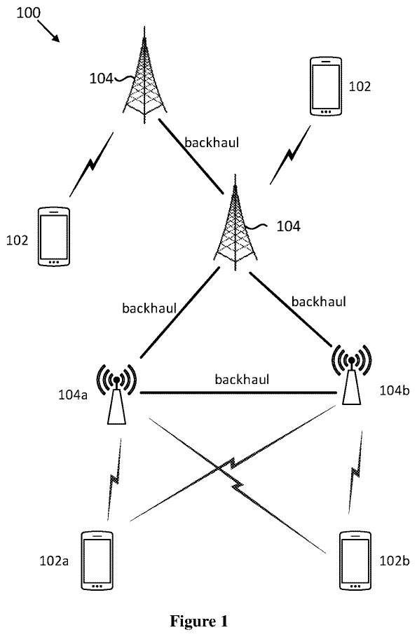

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

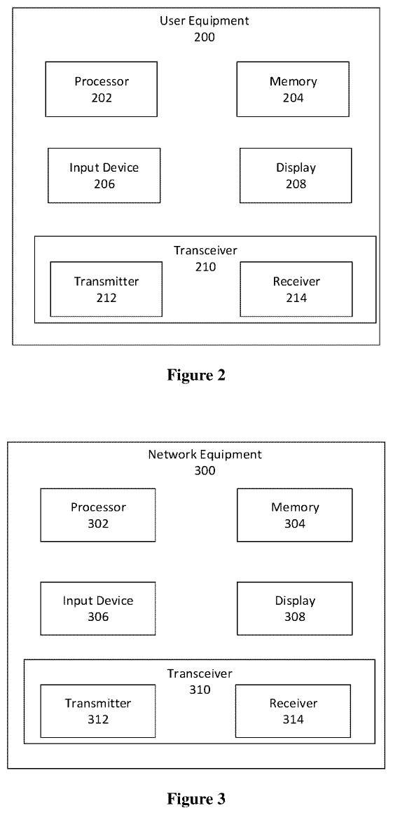

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

In 3GPP Technical Specification TS38.331, it is defined that the network or gNB may configure an RRC_CONNECTED UE, i.e., UE in RRC_CONNECTED state, to perform measurements. The network may configure the UE to report the measurement results in accordance with the measurement configuration or perform conditional reconfiguration evaluation in accordance with the conditional reconfiguration. The measurement configuration is provided by means of dedicated signalling, i.e., using the RRCReconfiguration or RRCResume information element.

The network may configure the UE to report the measurement information based on SS/PBCH block(s), CSI-RS resources, SRS resources or CLI-RSSI, or to perform CBR measurements for sidelink.

The measurement configuration includes the following parameters:
Measurement objects, as a list of objects (e.g., carrier frequency, reference signal (RS) frequency/time location) on which the UE shall perform the measurements;
Reporting configurations, as a list of reporting configurations (e.g., reporting criterion/format, RS type), where there may be one or multiple reporting configurations per measurement object;
Measurement identities, which link one measurement object with one reporting configuration, to be included in the measurement report, serving as a reference to the network;
Quantity configurations, which define the measurement filtering configuration used for all event evaluations and related reporting, and for periodical reporting of that measurement; and
Measurement gaps, as the periods that the UE may use to perform measurements.

A UE in RRC_CONNECTED state maintains a measurement object list, a reporting configuration list, and a measurement identities list according to signalling and procedures. The measurement object list possibly includes NR measurement object(s), Cross Link Interference (CLI) measurement object(s) and inter-RAT objects. Similarly, the reporting configuration list includes NR and inter-RAT reporting configurations. Any measurement object can be linked to any reporting configuration of the same RAT type.

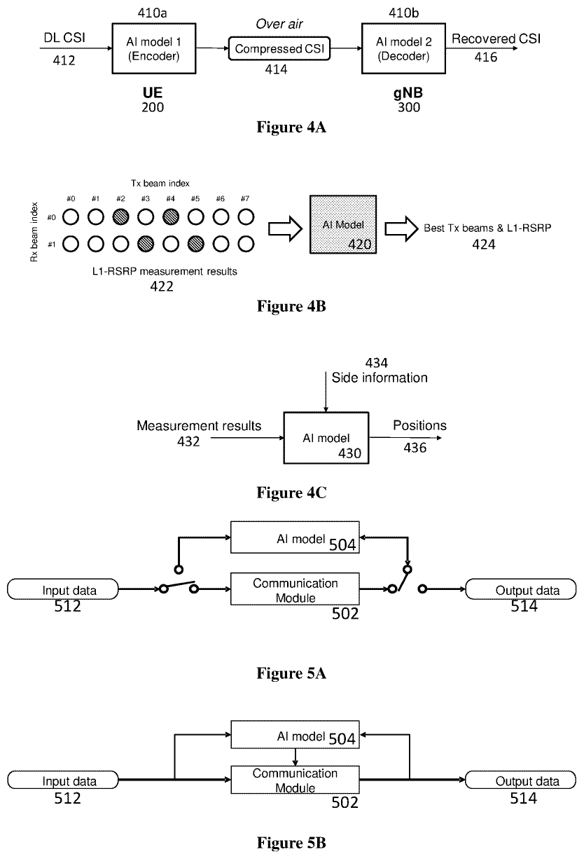

FIGS. 4A to 4C illustrate three use cases with AI/ML approach that are under study in Release 18, namely: 1) CSI feedback enhancement, 2) beam management, and 3) positioning accuracy improvement.

### CSI Feedback Enhancement

FIG. 4A is a schematic diagram illustrating an example of using AI/ML approach to compress CSI to reduce the CSI feedback overhead in accordance with some implementations of the present disclosure.

The potential objectives illustrated for CSI enhancements are overhead reduction, and improved accuracy and prediction. As shown in FIG. 4A, the AI-based approach to reduce the CSI feedback overhead may include an autoencoder (constructed by an encoder 410a and decoder 410b) trained to compress the downlink CSI. The encoder 410a, which is constructed with an NN, is deployed at UE side 200, and the decoder 410b, constructed with a paired NN, is deployed at gNB side 300.

With the structure, the DL CSI 412 is compressed by the encoder 410a with AI model 1, and the compressed CSI 414 as the output of AI model 1 is then transmitted over the air, whose overhead is supposed to be less than the traditional non-AI approach, i.e., Release 16 type-II codebook-based. The compressed CSI 414 is decoded at gNB 300 by the decoder 410b with AI model 2 to obtain the recovered CSI 416. In general, the input 412 of AI model 1 at UE 200 may be either raw channel or eigenvectors with pre-processing, and the output 416 of AI model 2 at gNB 300, i.e., the recovered CSI 416, may be the reconstructed channel or eigenvectors, respectively. The paired models (termed as Autoencoder in AI community) are supposed to be trained together with un-supervised learning, i.e., to minimize the difference between the input and output.

### Beam Management

FIG. 4B is a schematic diagram illustrating an example of using AI/ML approach for beam measurement with less overhead in accordance with some implementations of the present disclosure.

The key issues of the use cases for the beam management enhancement may be beam prediction in time, and/or spatial domain for overhead and latency reduction, and beam selection accuracy improvement. A typical deployment with an AI/ML approach is to apply an AI model to assist the best beams selection with less resources and potentially lower latency, as illustrated in FIG. 4B.

In this example, it is assumed that there are eight Tx beams, each being represented with a Tx beam index from #0 to #7; and two Rx beams, each being represented with a Rx beam index from #0 to #1. Each Tx beam and each Rx beam form a beam pair represented by a circle in FIG. 4B. Four of the beam pairs that are shaded may be measured, and the L1-RSRP measurement results 422 may be inputted into an AI model 420. With the trained AI model 420, using the measurement results from some resources, e.g., 4 from 16 as illustrated in the example, the best Tx beam indices and the corresponding L1-RSRP 424 may be obtained and reported.

In this case, if the AI model 420 is trained for and deployed at the UE side, the gNB may potentially configure less CSI-RS resources, or the UE may use less resources for the beam training or beam tracking, which can reduce the RS overhead and processing latency at the UE side.

### Positioning Accuracy Enhancement

FIG. 4C is a schematic diagram illustrating an example of using AI/ML approach to enhance positioning accuracy in accordance with some implementations of the present disclosure.

The key issue in this case is to enhance positioning accuracy with AI/ML approach in the scenario with heavy Non Line of Sight (NLOS) conditions, since the positioning accuracy is not good enough with the traditional approach. A typical deployment with an AI/ML approach is illustrated in FIG. 4C.

In this example, based on the input of measurement results 432, and optionally some side information 434, the AI model 430 may provide the estimated positions 436.

With this approach, the positions, e.g., locations of gNBs, can be estimated with the measurement results and possible side information.

In 3GPP Release 18, it is expected to introduce AI/ML approach to improve and/or enhance the system performance, especially the air interface performance. In some examples, the AI/ML model may be used as a “replacement” or an “accessory” as illustrated in FIGS. 5A and 5B.

FIG. 5A is a schematic diagram illustrating an example of replacing a communication module with an AI model in accordance with some implementations of the present disclosure. The AI model 504 is used as a replacement of the communication module 502 since the input data 512 may be input to either the communication module 502 or the AI model 504 to obtain the output data 514. FIG. 5B is a schematic diagram illustrating an example of assisting the communication module with an AI model in accordance with some implementations of the present disclosure. The AI model 504 is used together with the communication module 502 as the input data 512 is input to both the communication module 502 and the AI model 504.

Under the current 3GPP specifications, the communication modules, including the signal processing modules and protocol realizations satisfying the specifications, can always work to support the radio connection between nodes. Thus, the deployment of AI model for the air interface may be enabled or disabled.

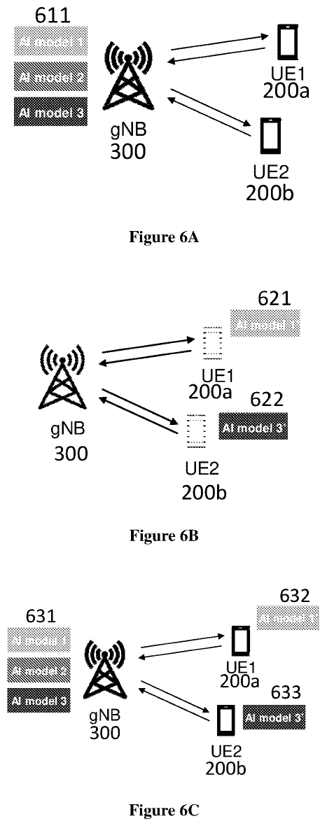

In general, the AI function may be deployed at the gNB side only, the UE side only, or at both sides. FIGS. 6A-6C are schematic diagrams illustrating examples of AI model deployment cases with AI model at gNB side, at UE side, and at both sides, respectively, in accordance with some implementations of the present disclosure. In FIG. 6A, three AI models 611, including AI model 1, AI model 2 and AI model 3, are deployed at gNB 300; in FIG. 6B, two AI models are deployed at the UE side, where AI model 1′ 621 is deployed at UE1 200a and AI model 3′ 622 is deployed at UE2 200b; and in FIG. 6C, three AI models 631 are deployed at gNB 300, and at the same time, AI model 1′ 632 is deployed at UE1 200a and AI model 3′ 633 is deployed at UE2 200b.

To monitor the performance of the AI models, there have been two straightforward kinds of methods: one (i.e., Method A) is to directly compare the results of the AI model with the non-AI approach (Method A-1) or the ground truth (Method A-2); the other (i.e., Method B) is to indirectly monitor the link performance with the AI model. These methods are explained as follows.
Method A-1: comparing the inference results of AI model with the non-AI approach.
   In this method, the results of AI approach and non-AI approach are compared; and if the result of AI approach is better than the non-AI approach, the AI model may be regarded as a proper and healthy one. Otherwise, the AI model is considered as under-performed. However, in the method, it may be necessary to duplicate the signal processing, that is, one to use AI approach, and the other to use non-AI approach, which results in extra processing overhead.
Method A-2: comparing the inference results of AI model with the ground truth if available.
   In this method, the result of AI approach is compared with the ground truth, if the ground truth is available. If the difference, e.g., mean squared error (MSE), is larger than a threshold, the AI model may be regarded as an under-performed one. However, in the method, the ground truth needs to be available at the node, which may need extra transmission overhead.
Method B: monitoring the AI model enhanced radio link performance, such as throughput and BLER.
   In this method, the traditional measurement methods can be used, and if the measurement results with an AI approach become worse, i.e., an expected degradation is detected, the AI model may be regarded as an under-performed one. However, the radio link may be degraded by a lot of factors, such as fading and interference.

The above typical methods to monitor the deployed AI model may require different signalings over the air interface.

In this disclosure, a set of signalings to support AI model performance monitoring procedure are proposed, including signalings for the registration, configuration, event triggering and results report. The disclosure focuses on the cases that the AI model is deployed for inference at the UE side, i.e., cases illustrated in FIGS. 6B and 6C.

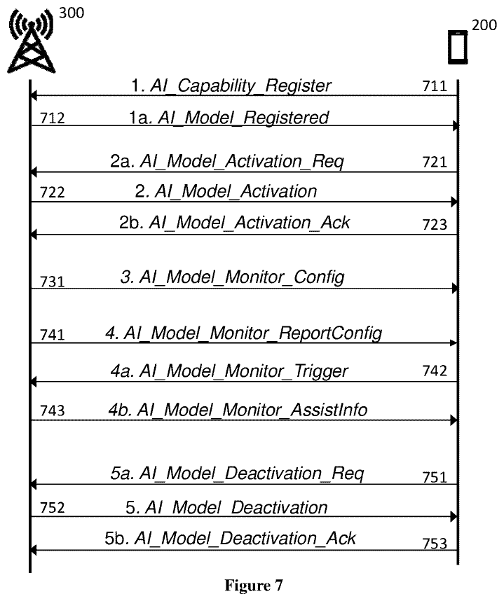

FIG. 7 is a schematic diagram illustrating an example of AI model performance monitoring procedure in accordance with some implementations of the present disclosure. The AI model performance monitoring procedure proposed includes five main steps with corresponding signalings: AI capability registering, AI model activation, AI model monitoring configuration, AI model monitoring results reporting and AI model deactivation.

In some examples, these five steps may not be performed in the order as presented in FIG. 7, and some of the steps may even be omitted.

In general, the UE with the AI capability may be firstly registered in the network to indicate the deployed AI models, i.e., AI capability registering. The signalings that may be used in the step are AI_Capability_Register 711 and AI_Model_Registered 712.

Once the scenario and configuration satisfy the condition of activation of an AI model, the corresponding AI model may be activated and applied for the subsequent operations, such as compressing the CSI and predicting the beams, i.e., AI model activation. The signalings that may be used in the step are AI_Model_Activation_Req 721, AI_Model_Activation 722 and AI_Model_Activation Ack 723.

With the activated models, the performance may then be monitored occasionally; and the monitoring behaviour may be configured in the newly designed configuration, i.e., AI model monitoring configuration. The signalling that may be used in the step is AI_Model_Monitor_Config 731.

According to the further configurations, relevant interactions, including the assistance information and the report, may be further defined, and the AI model monitoring results are reported accordingly, i.e., AI model monitoring results reporting. The signalings that may be used in the step are AI_Model_Monitor_ReportConfig 741, AI_Model_Monitor_Trigger 742 and AI_Model_Monitor_AssistInfo 743.

If the activated model is found to be under-performed, it will be de-activated, i.e., AI model deactivation. The signalings that may be used in the step are AI_Model_Deactivation_Req 751, AI_Model_Deactivation 752 and AI_Model_Deactivation Ack 753.

The signalings may be transmitted with Radio Resource Control (RRC) Information Element (IE), Media Access Control-Control Element (MAC-CE), and/or Downlink Control Information (DCI).

In details, the signalings within the steps are designed and explained as follows with reference to FIG. 7. In this disclosure, a message or signalling sent by the gNB for configuring the UE may also be referred to as a “configuration signalling”.

### AI Capability Registering: AI_Capability_Register

If a UE, e.g., UE 200, has the capability to support AI-based approaches, a message may be used to indicate such capability to the network or gNB 300 and cause the deployed AI models to be registered in the network. The message or signalling, i.e., AI_Capability_Register 711, may include one or more items of the following information:
The descriptions of the hardware to support an AI model (i.e., neural network, NN), such as the Floating Point Operations Per Second (FLOPS), memory size and bit width, for the AI models to be registered;
The descriptions of the software to accelerate the operations for an NN, such as the algorithms optimized for convolutional NN or dense NN;
The descriptions and the identifications of the deployed AI models to enhance the communication modules, such as the models for CSI feedback compression or beam management;
The descriptions of the scenarios and/or configurations of the deployed AI models to assist the network to decide the model selection, such as Non Line of Sight (NLOS)/Line of Sight (LOS), indoor/outdoor; and
The required input and/or output information for the AI model training (e.g. offline/online) and inference, for example, some AI models used for beam prediction requiring assistant information, such as UE position, and measured beams as input.

That is, the UE may send a message indicating a set of AI models to be registered to the network, and the message may include a model identification (ID), one or more deployment scenarios, and configuration parameters, for each corresponding AI model in the set of AI models.

After receiving this message, the models deployed in the UE will be registered with the corresponding identifications at the network. The network 300 may acknowledge the registered AI models to the UE, with the signalling such as AI_Model_Registered 712, by proper selection processing.

The registered models for a UE may be managed in a table, an example of which is illustrated in Table 1, which may be configured by the network according to the UE capability.

TABLE 1
The registered AI models

| | PHY module 1 | PHY module 2 (e.g., | PHY module 3 (e.g., |
|---|---|---|---|
| | (e.g., CSI report) | Beam Management) | Positioning) |
| Scenario 1 (e.g., | Model 1-1 | Model 1-2 | Model 1-3 |
| indoor) | | | |
| Scenario 2 (e.g., | Model 2-1 | Model 2-2 | Model 2-3 |
| urban) | | | |
| Scenario 3 (e.g., | Model 3-1 | Model 3-2 | Model 3-3 |
| HST) | | | |

In the example of Table 1, the registered AI models are specified for three different scenarios for each of three use cases discussed above.

In some examples, the information to register the AI capability may also be reported as part of the current UE capability reporting.

### AI Model Activation: AI_Model_Activation

The signal, i.e., AI_Model_Activation 722, is used to activate one or more AI models that are registered in the network when some conditions, e.g., scenarios and/or configurations of the registered models, are satisfied.

The signal may include one or more items of the following information:
The model identification to be activated for the UE, which is selected from the models registered to the network in the previous step of AI capability registering;
The association information for the UE to activate the model or not, such as the required computation resources for the AI operations. One example of the computation resources is the inference time (e.g., processing latency) which is defined as the period from the slot in which the UE receives the input for the AI model to the first UL symbol to obtain the corresponding AI output, which may be defined as the number of symbols per SCS;
The duration of the model activation to indicate how long the model is activated after receiving the signal, which is defined as the time between the UE receives the activation command to the first symbol/slot in which the model is ready to be used; and
The duration of the model activation to indicate how long the model is activated before being de-activated.

That is, the configuration signalling for activating one or more AI models that are registered in the network may be transmitted to the UE and include a model ID and associated requirements on operations, for each AI model to be activated.

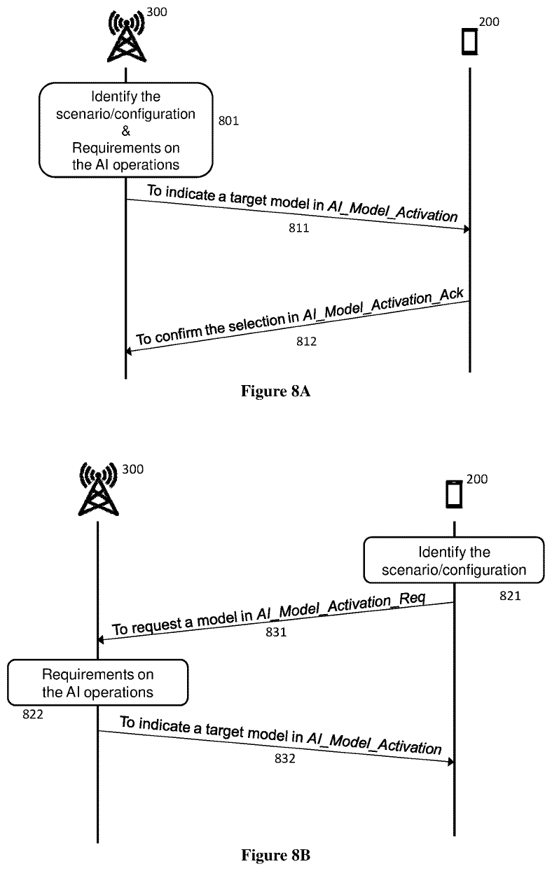

By default, the scenario and configuration of the UE are estimated and decided by the network, which may have more environment information than the UE. FIG. 8A is a schematic diagram illustrating an example of AI model activation procedure with scenario identification at gNB or network side in accordance with some implementations of the present disclosure. As shown in FIG. 8A, after the network or gNB 300 identifies or estimates the scenario and configuration of the UE and the associated requirements on the AI operations 801, the network or gNB 300 indicates a target model to be activated 811 in the signal AI_Model_Activation 722 to the UE 200. If the requirements (e.g., latency) can be satisfied for the activated model (i.e., the target model), the UE 200 will confirm the selection of the model 812 by sending an acknowledgement back to the network or gNB via AI_Model_Activation_Ack 723 to indicate whether it agrees to activate, or is capable of activating, the model or not, since the UE may not be able to support the model in some cases, such as cases demanding high computation load.

In an example, if the gNB or network estimates that the registered UE is in a scenario defined in Table 1, e.g., Scenario 2, then it would try to activate the Model 2-1 to enhance the CSI report module for the UE. Because the network has no information on the computation load in the UE, the recommended requirements on the AI operations are also associated for reference.

In some cases, the UE is able to identify the scenario and configuration itself. FIG. 8B is a schematic diagram illustrating an example of AI model activation procedure with scenario identification at UE side in accordance with some implementations of the present disclosure. In the example illustrated in FIG. 8B, the UE 200 identifies the scenario and configuration 821, and it requests the network or gNB 300 to active the corresponding AI models 831 via AI_Model_Activation Req 721. The signal may include the following information:
The identification of the recommended model, which is ever registered at the network.

In some examples, it is assumed that the network will decide whether to activate a model or not, and the UE may only provide the recommendation. Therefore, after receiving the AI_Model_Activation_Req 721 from the UE 200, the network 300 identifies 822 requirements on the AI operations and indicates 832 a target model to the UE 200 via AI_Model_Activation 722.

In this case where the model is requested or recommended by the UE via AI_Model_Activation_Req 721, acknowledgement information (i.e., AI_Model_Activation_Ack 723) is not necessary since the network decides whether to activate the model or not according to the reported overhead in AI_Model_Activation_Req 721.

The activation message may be transmitted with RRC IE, MAC-CE, or DCI.

If the activation message is transmitted by RRC, e.g., RRC reconfiguration message, the acknowledgement signal or message may be the RRC reconfiguration complete message.

If the activation message is transmitted by MAC CE, the acknowledgement message may be the HARQ-ACK corresponding to the PDSCH carrying the MAC CE, and the activated model shall be applied starting from the first slot after slot

$$n + 3 {N}_{slot}^{sfn , μ} ,$$

where n is the slot in which the HARQ-ACK is transmitted and

$${N}_{slot}^{sfn , μ}$$

is the number of slots per subframe for subcarrier spacing configuration μ.

If the activation message is transmitted by a DCI with DL assignment, the acknowledgement message may be a dedicated MAC CE in response to receiving or applying the model activation command; or the acknowledgement message is the HARQ-ACK corresponding to the scheduled PDSCH, and the activation shall be applied starting from the first slot after slot n+M, where M is number of OFDM symbols per SCS reported or configured according to UE capability.

In some other examples, the UE may decide to activate an AI model when it identifies the scenario and configuration, and report the activated AI model to the gNB.

### AI Model Monitoring Configuration: AI_Model_Monitor_Config

After one or more AI models are activated at the UE side, the performance of the activated models will be monitored according to the monitoring configuration, termed as AI_Model_Monitor_Config 731 in this example, which may include one or more items of the following information for monitoring UE behaviour:
The model identification(s) to be monitored for the UE, which is (are) selected from the activated models in the previous step of AI model activation;
The timing information for performance monitoring. In the time domain, performing AI model performance monitoring may be configured in periodic, semi-persistent, or aperiodic approach.
   For periodic monitoring, the value of the periodicity is configured.
   For semi-persistent monitoring, a certain periodicity is configured via MAC CE.
   For aperiodic monitoring, no periodicity is configured, and a UE is explicitly triggered by each operation of monitoring such as by means of DCI signalling.
The events definition for the UE to trigger the performance monitoring, such as a threshold and/or timer to report, which are/is related with the message of AI_Model_Monitor_Trigger;
The identifications of the candidate AI model(s) for the UE to monitor, which enable the UE to further derive the results with respect to the candidate AI models for the subsequent de-activation and activation;
The indication on the reference signals to be measured on if the model needs, such as the CSI-RS/SSB for the AI model for beam management.

In the present disclosure, the AI_Model_Monitor_Config 731 may also be referred to as the configuration signalling for monitoring performance of one or more Artificial Intelligence (AI) models that are activated. The configuration signalling for monitoring performance of activated AI models may include a model ID, and timing information and/or triggering event for the monitoring, for each of the AI models to be monitored. It may also include timing information and/or triggering event for reporting the result of the performance monitoring.

The UE follows the configuration in AI_Model_Monitor_Config 731 to perform measurement to monitor the model performance on the monitoring occasions and report the results correspondently.

### AI Model Monitoring Results Reporting: AI_Model_Monitor_ReportConfig

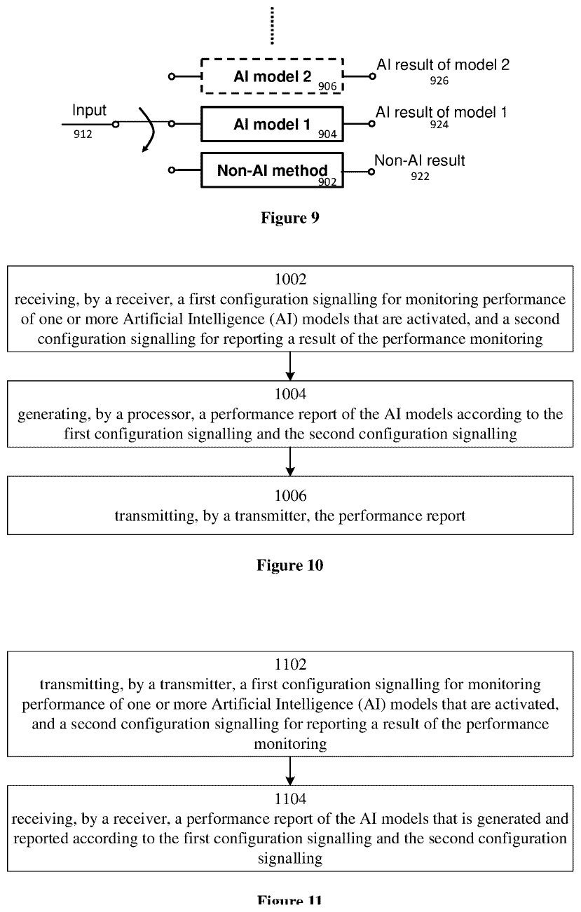

In the step of AI model monitoring results reporting, the model monitoring results, associated with one AI_Model_Monitor_Config 731, will be reported as a kind of measurement results according to the report configuration. The AI_Model_Monitor_ReportConfig 741 may include one or more items of the following information:
The model identification(s) of the monitored model, which should be the same as the identification(s) in the corresponding monitoring configuration, i.e., AI_Model_Monitor_Config.
The measurement results of the model to be monitored, such as the output of the AI model and non-AI approach, the performance gap between the monitored AI model and the non-AI approach (i.e., the baseline) and/or the performance gap between the monitored AI model and the candidate AI model(s) if configured. FIG. 9 is a schematic diagram illustrating an example of measurement trigger to monitor an activated AI model in accordance with some implementations of the present disclosure. In this example, three different measurement results are available resulting from the same input 912, based on three different methods/models. There are: 1) non-AI result 922 based on non-AI method 902, 2) AI result of model 1 924 based on AI model 1 904, and 3) AI result of model 2 926 based on AI model 2 906. For example, where the performance of AI model 1 904 is to be monitored, the performance gap between the monitored AI model and the non-AI approach may be the gap between results 924 and 922; and the performance gap between the monitored AI model and the candidate AI model may be the gap between results 924 and 926.
The monitoring report configuration, such as the type of contents (e.g., either the outputs of the AI model and non-AI approach or the gaps between them) and the transmission format (e.g., PUSCH or PUCCH).
The indication for the UE to enable the baseline, i.e., non-AI approach, to derive the results to report as the reference for the performance monitoring.
   Alternatively, a baseline function without AI function, e.g., a CSI-ReportConfig without AI model, can be associated with a CSI-ReportConfig with AI model for monitoring.
The computation resource consumption indications of the model, such as the processing latency, and/or power consumption.

In the present disclosure, the AI_Model_Monitor_ReportConfig 741 may also be referred to as the configuration signalling for reporting a result of the performance monitoring. The configuration signalling for reporting the result of the performance monitoring may include model ID, content, and format of transmission, for the performance report.

Accordingly, the monitoring report or the performance report may include measurement result of output of a monitored AI model, measurement result of output of an indicated non-AI approach, measurement result of a performance gap between the monitored AI model and the indicated non-AI approach and/or between the monitored AI model and other AI models, and computation overhead.

The content of the monitoring report may be multiplexed in PUSCH or PUCCH, according to the configuration. It is noted that the reporting may be periodic, semi-persistent, or aperiodic, following the configuration of its corresponding monitoring operation.

As mentioned in the step of AI model monitoring configuration, if the UE is configured to trigger the report by local measurements, the report will be triggered, if the pre-configured condition is satisfied, i.e., the output of the monitored AI model is under-performed compared to the non-AI approach or the candidate AI model(s) according to the configured threshold. The event-triggered signalling, termed as AI_Model_Monitor_Trigger 742, will be sent from the UE, which may include one or more items of the following information:
The indication of the under-performing event for an activated AI model;
The model identification of the under-performed AI model, which should be the indicated model for the performance monitoring;
The identification(s) of the candidate model(s) for measurement.

As an event-triggered signalling, this message can only be a MAC CE for event-triggered monitoring or a DCI for the aperiodic monitoring configured in advance.

Optionally, a signalling to indicate the assistance information, AI_Model_Monitor_AssistInfo 743, to assist the monitoring may be sent to the UE, which may include the following information:
The ground-truth data transmission for the monitoring of the target model;

In general, enabling more approaches (non-AI approach and other AI models, i.e., the candidate AI models) to monitor the model performance may require more power consumption and complexity. Thus, there may be some trade-off between the proper model selection and beneficial performance from model.

### AI Model Deactivation: AI_Model_Deactivation

If the configured activation duration ends or the performance of the activated AI model is worse than the non-AI approach or other AI models with a threshold for several times, where the threshold and the number of times are defined in the monitoring configuration, the model will be de-activated accordingly by the signal AI_Model_Deactivation 752, which may include one or more items of the following information:
The model identification to be de-activated, which should be one of the activated models; and
The identification of the recommended model for the next activation if any.

That is, the deactivation signal or message from the network to the UE includes one or more model IDs to be deactivated; and it may further include one or more model IDs for recommended AI models.

In some cases, if the UE can identify the scenario or configuration and/or under-performance by itself, it may request the network to de-activate the AI models via AI_Model_Deactivation_Req 751, which includes the identification of the model to be deactivated, and the value representing the cause of deactivation which may be added to the deactivation request sent by the UE, e.g., the deactivation may be requested due to degraded performance, or lack of processing capability, etc. It is up to the network to finally decide whether to deactivate the AI model or not, and to send the deactivation signal AI_Model_Deactivation 752 to the UE 200.

Once the deactivation signal from the network is received, the UE 200 may send the acknowledgement back to the network via AI_Model_Deactivation_Ack 753 to indicate deactivating the model or not. After de-activation, the model will not be used to derive the result until being activated again.

FIG. 10 is a flow chart illustrating steps of monitoring AI model in RAN by UE 200 in accordance with some implementations of the present disclosure.

At step 1002, the receiver 214 of UE 200 a first configuration signalling for monitoring performance of one or more Artificial Intelligence (AI) models that are activated, and a second configuration signalling for reporting a result of the performance monitoring.

At step 1004, the processor 202 of UE 200 generates a performance report of the AI models according to the first configuration signalling and the second configuration signalling.

At step 1006, the transmitter 212 of UE 200 transmits the performance report.

FIG. 11 is a flow chart illustrating steps of monitoring AI model in RAN by gNB 300 in accordance with some implementations of the present disclosure.

At step 1102, the transmitter 312 of gNB 300 transmits a first configuration signalling for monitoring performance of one or more Artificial Intelligence (AI) models that are activated, and a second configuration signalling for reporting a result of the performance monitoring.

At step 1104, the receiver 314 of gNB 300 receives a performance report of the AI models that is generated and reported according to the first configuration signalling and the second configuration signalling.

In one aspect, some items as examples of the disclosure concerning UE may be summarized as follows:

1. An apparatus, comprising:
a receiver that receives a first configuration signalling for monitoring performance of one or more Artificial Intelligence (AI) models that are activated, and a second configuration signalling for reporting a result of the performance monitoring;
a processor that generates a performance report of the AI models according to the first configuration signalling and the second configuration signalling; and
a transmitter that transmits the performance report.

2. The apparatus of item 1, wherein the transmitter further transmits a first message indicating a set of AI models to be registered.

3. The apparatus of item 2, wherein the receiver further receives a third configuration signalling for activating a subset of the AI models.

4. The apparatus of item 2, wherein the first message comprises: a model identification (ID), one or more deployment scenarios, and configuration parameters, for each corresponding AI model in the set of AI models.

5. The apparatus of item 3, wherein the third configuration signalling comprises: a model ID and associated requirements on operations, for each activated AI model in the subset of the AI models.

6. The apparatus of item 5, wherein the transmitter further transmits a request message for triggering transmission of the third configuration signalling.

7. The apparatus of item 1, wherein the first configuration signalling comprises: a model ID, and timing information and/or triggering event for the monitoring, for each of the AI models to be monitored.

8. The apparatus of item 7, wherein the first configuration signalling further comprises timing information and/or triggering event for reporting the result of the performance monitoring.

9. The apparatus of item 1, wherein the second configuration signalling comprises: model ID, content, and format of transmission, for the performance report.

10. The apparatus of item 1 or 9, wherein the performance report comprises: measurement result of output of a monitored AI model, measurement result of output of an indicated non-AI approach, measurement result of a performance gap between the monitored AI model and the indicated non-AI approach and/or between the monitored AI model and other AI models, and computation overhead.

11. The apparatus of item 1, wherein the transmitter further transmits a second message for deactivating one or more of the AI models that are activated.

12. The apparatus of item 11, wherein the second message comprise one or more model IDs to be deactivated.

13. The apparatus of item 12, wherein the second message further comprises one or more model IDs for recommended AI models.

14. The apparatus of item 11, wherein the receiver further receives a fourth configuration signalling for deactivation of one or more AI models.

15. The apparatus of any one of items 1 to 14, wherein the configuration signalings and the messages are transmitted with Radio Resource Control (RRC) Information Element (IE), Media Access Control-Control Element (MAC-CE), and/or Downlink Control Information (DCI).

In another aspect, some items as examples of the disclosure concerning gNB may be summarized as follows:

16. An apparatus, comprising:
a transmitter that transmits a first configuration signalling for monitoring performance of one or more Artificial Intelligence (AI) models that are activated, and a second configuration signalling for reporting a result of the performance monitoring;
a receiver that receives a performance report of the AI models that is generated and reported according to the first configuration signalling and the second configuration signalling.

17. The apparatus of item 16, wherein the receiver further receives a first message indicating a set of AI models to be registered.

18. The apparatus of item 17, wherein the transmitter further transmits a third configuration signalling for activating a subset of the AI models.

19. The apparatus of item 17, wherein the first message comprises: a model identification (ID), one or more deployment scenarios, and configuration parameters, for each corresponding AI model in the set of AI models.

20. The apparatus of item 18, wherein the third configuration signalling comprises: a model ID and associated requirements on operations, for each activated AI model in the subset of the AI models.

21. The apparatus of item 20, wherein the receiver further receives a request message for triggering transmission of the third configuration signalling.

22. The apparatus of item 16, wherein the first configuration signalling

comprises: a model ID, and timing information and/or triggering event for the monitoring, for each of the AI models to be monitored.

23. The apparatus of item 22, wherein the first configuration signalling further comprises timing information and/or triggering event for reporting the result of the performance monitoring.

24. The apparatus of item 16, wherein the second configuration signalling comprises: model ID, content, and format of transmission, for the performance report.

25. The apparatus of item 16 or 24, wherein the performance report comprises: measurement result of output of a monitored AI model, measurement result of output of an indicated non-AI approach, measurement result of a performance gap between the monitored AI model and the indicated non-AI approach and/or between the monitored AI model and other AI models, and computation overhead.

26. The apparatus of item 16, wherein the receiver further receives a second message for deactivating one or more of the AI models that are activated.

27. The apparatus of item 26, wherein the second message comprise one or more model IDs to be deactivated.

28. The apparatus of item 27, wherein the second message further comprises one or more model IDs for recommended AI models.

29. The apparatus of item 26, wherein the transmitter further transmits a fourth configuration signalling for deactivation of one or more AI models.

30. The apparatus of any one of items 16 to 29, wherein the configuration signalings and the messages are transmitted with Radio Resource Control (RRC) Information Element (IE), Media Access Control-Control Element (MAC-CE), and/or Downlink Control Information (DCI).

In a further aspect, some items as examples of the disclosure concerning a method of UE may be summarized as follows:

31. A method, comprising:
receiving, by a receiver, a first configuration signalling for monitoring performance of one or more Artificial Intelligence (AI) models that are activated, and a second configuration signalling for reporting a result of the performance monitoring;
generating, by a processor, a performance report of the AI models according to the first configuration signalling and the second configuration signalling; and
transmitting, by a transmitter, the performance report.

32. The method of item 31, wherein the transmitter further transmits a first message indicating a set of AI models to be registered.

33. The method of item 32, wherein the receiver further receives a third configuration signalling for activating a subset of the AI models.

34. The method of item 32, wherein the first message comprises: a model
identification (ID), one or more deployment scenarios, and configuration parameters, for each corresponding AI model in the set of AI models.

35. The method of item 33, wherein the third configuration signalling comprises: a model ID and associated requirements on operations, for each activated AI model in the subset of the AI models.

36. The method of item 35, wherein the transmitter further transmits a request message for triggering transmission of the third configuration signalling.

37. The method of item 31, wherein the first configuration signalling comprises: a model ID, and timing information and/or triggering event for the monitoring, for each of the AI models to be monitored.

38. The method of item 37, wherein the first configuration signalling further comprises timing information and/or triggering event for reporting the result of the performance monitoring.

39. The method of item 31, wherein the second configuration signalling comprises: model ID, content, and format of transmission, for the performance report.

40. The method of item 31 or 39, wherein the performance report comprises: measurement result of output of a monitored AI model, measurement result of output of an indicated non-AI approach, measurement result of a performance gap between the monitored AI model and the indicated non-AI approach and/or between the monitored AI model and other AI models, and computation overhead.

41. The method of item 31, wherein the transmitter further transmits a second message for deactivating one or more of the AI models that are activated.

42. The method of item 41, wherein the second message comprise one or more model IDs to be deactivated.

43. The method of item 42, wherein the second message further comprises one or more model IDs for recommended AI models.

44. The method of item 41, wherein the receiver further receives a fourth configuration signalling for deactivation of one or more AI models.

45. The method of any one of items 31 to 44, wherein the configuration signalings and the messages are transmitted with Radio Resource Control (RRC) Information Element (IE), Media Access Control-Control Element (MAC-CE), and/or Downlink Control Information (DCI).

In a yet further aspect, some items as examples of the disclosure concerning a method of gNB may be summarized as follows:

46. A method, comprising:
transmitting, by a transmitter, a first configuration signalling for monitoring performance of one or more Artificial Intelligence (AI) models that are activated, and a second configuration signalling for reporting a result of the performance monitoring;
receiving, by a receiver, a performance report of the AI models that is generated and reported according to the first configuration signalling and the second configuration signalling.

47. The method of item 46, wherein the receiver further receives a first message

indicating a set of AI models to be registered.

48. The method of item 47, wherein the transmitter further transmits a third configuration signalling for activating a subset of the AI models.

49. The method of item 47, wherein the first message comprises: a model identification (ID), one or more deployment scenarios, and configuration parameters, for each corresponding AI model in the set of AI models.

50. The method of item 48, wherein the third configuration signalling comprises: a model ID and associated requirements on operations, for each activated AI model in the subset of the AI models.

51. The method of item 50, wherein the receiver further receives a request message for triggering transmission of the third configuration signalling.

52. The method of item 46, wherein the first configuration signalling comprises: a model ID, and timing information and/or triggering event for the monitoring, for each of the AI models to be monitored.

53. The method of item 52, wherein the first configuration signalling further comprises timing information and/or triggering event for reporting the result of the performance monitoring.

54. The method of item 46, wherein the second configuration signalling comprises: model ID, content, and format of transmission, for the performance report.

55. The method of item 46 or 54, wherein the performance report comprises: measurement result of output of a monitored AI model, measurement result of output of an indicated non-AI approach, measurement result of a performance gap between the monitored AI model and the indicated non-AI approach and/or between the monitored AI model and other AI models, and computation overhead.

56. The method of item 46, wherein the receiver further receives a second message for deactivating one or more of the AI models that are activated.

57. The method of item 56, wherein the second message comprise one or more model IDs to be deactivated.

58. The method of item 57, wherein the second message further comprises one or more model IDs for recommended AI models.

59. The method of item 56, wherein the transmitter further transmits a fourth configuration signalling for deactivation of one or more AI models.

60. The method of any one of items 46 to 59, wherein the configuration signalings and the messages are transmitted with Radio Resource Control (RRC) Information Element (IE), Media Access Control-Control Element (MAC-CE), and/or Downlink Control Information (DCI).

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and configured to cause the UE to:
receive a first configuration signalling for performance monitoring of one or more Artificial Intelligence (AI) models that are activated, and a second configuration signalling for reporting a result of the performance monitoring;
generate a performance report of the one or more AI models according to the first configuration signalling and the second configuration signalling; and
transmit the performance report.

2. The UE of claim 1, wherein the at least one processor is further configured to cause the UE to transmit a first message indicating a set of AI models to be registered.

3. The UE of claim 2, wherein the at least one processor is further configured to cause the UE to receive a third configuration signalling for activating a subset of AI models of the set of AI models.

4. The UE of claim 2, wherein the first message comprises: a model identification (ID), one or more deployment scenarios, and configuration parameters, for each corresponding AI model in the set of AI models.

5. The UE of claim 3, wherein the third configuration signalling comprises: a model identification (ID) and associated requirements on operations, for each activated AI model in the subset of the set of AI models.

6. The UE of claim 5, wherein the at least one processor is further configured to cause the UE to transmit a request message for triggering transmission of the third configuration signalling.

7. The UE of claim 1, wherein the first configuration signalling comprises: a model identification (ID), and one or more of timing information or a triggering event for the performance monitoring, for each of the one or more AI models to be monitored.

8. The UE of claim 7, wherein the first configuration signalling further comprises one or more of timing information or a triggering event for reporting the result of the performance monitoring.

9. The UE of claim 1, wherein the second configuration signalling comprises: model identification (ID), content, and format of transmission, for the performance report.

10. The UE of claim 1, wherein the performance report comprises: measurement result of output of a monitored AI model, measurement result of output of an indicated non-AI approach, a measurement result of a performance gap between one or more of the monitored AI model and the indicated non-AI approach or between the monitored AI model and other AI models, and computation overhead.

11. The UE of claim 1, wherein the at least one processor is further configured to cause the UE to transmit a second message for deactivating one or more AI models that are activated.

12. The UE of claim 11, wherein one or more of:
the second message comprise one or more model identifications (IDs) to be deactivated;
the second message further comprises one or more model IDs for recommended AI models; or
the at least one processor is further configured to cause the UE to receive a fourth configuration signalling for deactivation of one or more AI models.

13. The UE of claim 1, wherein one or more of the first configuration signalling or the second configuration signalling are received with one or more of Radio Resource Control (RRC) Information Element (IE), Media Access Control-Control Element (MAC-CE), or Downlink Control Information (DCI).

14. A network equipment (NE) for wireless communication, comprising:
at least one memory; and
at least one processor coupled with the at least one memory and configured to cause the NE to:
transmit a first configuration signalling for performance monitoring of one or more Artificial Intelligence (AI) models that are activated, and a second configuration signalling for reporting a result of the performance monitoring; and
receive a performance report of the AI models that is generated and reported according to the first configuration signalling and the second configuration signalling.

15. A method performed by a user equipment (UE), the method comprising:
receiving a first configuration signalling for performance monitoring of one or more Artificial Intelligence (AI) models that are activated, and a second configuration signalling for reporting a result of the performance monitoring;
generating a performance report of the one or more AI models according to the first configuration signalling and the second configuration signalling; and
transmitting the performance report.

16. A processor for wireless communication, comprising:
at least one controller coupled with at least one memory and configured to cause the processor to:
receive a first configuration signalling for performance monitoring of one or more Artificial Intelligence (AI) models that are activated, and a second configuration signalling for reporting a result of the performance monitoring;
generate a performance report of the one or more AI models according to the first configuration signalling and the second configuration signalling; and
transmit the performance report.

17. The processor of claim 16, wherein the at least one controller is further configured to cause the processor to transmit a first message indicating a set of AI models to be registered.

18. The processor of claim 17, wherein the at least one controller is further configured to cause the processor to receive a third configuration signalling for activating a subset of AI models of the set AI models.

19. The processor of claim 17, wherein the first message comprises: a model identification (ID), one or more deployment scenarios, and configuration parameters, for each corresponding AI model in the set of AI models.

20. The processor of claim 18, wherein the third configuration signalling comprises: a model identification (ID) and associated requirements on operations, for each activated AI model in the subset of AI models.
